(19) United States
(12) Patent Application Publication
(10) Pub. No.: US 2010/0313889 A1
(43) Pub. Date: Dec. 16, 2010

(54) Second-Stage Valve for Breathing-Gas Regulator for Air Aqualung for Underwater Activity

(76) Inventor: Dante Noceti, Santa Margherita Ligure (IT)

Correspondence Address: STITES & HARBISON PLLC, 1199 NORTH FAIRFAX STREET, SUITE 900, ALEXANDRIA, VA, 22314, US

(21) Appl. No.: 12/789,714

(22) Filed: May 28, 2010

(30) Foreign Application Priority Data
Jun. 10, 2009 (IT) GE2009U000006

(51) Int. Cl. A62B 9/02

(52) U.S. Cl. 128/205.24

(57) ABSTRACT

Second-stage valve for a breathing-gas regulator for an air aqualung for underwater activity, of the type comprising a chamber which houses the stem of an open/close element that is pushed permanently in a direction of closure against the seat of the breathing-air release valve by a spring, the free end of this stem being connected to a lever that works in conjunction with a constant-pressure diaphragm and that opens said valve in opposition to the action of said spring, said valve being characterized in that said chamber comprises a thin metal inner liner coated with a coating of plastic or composite material.

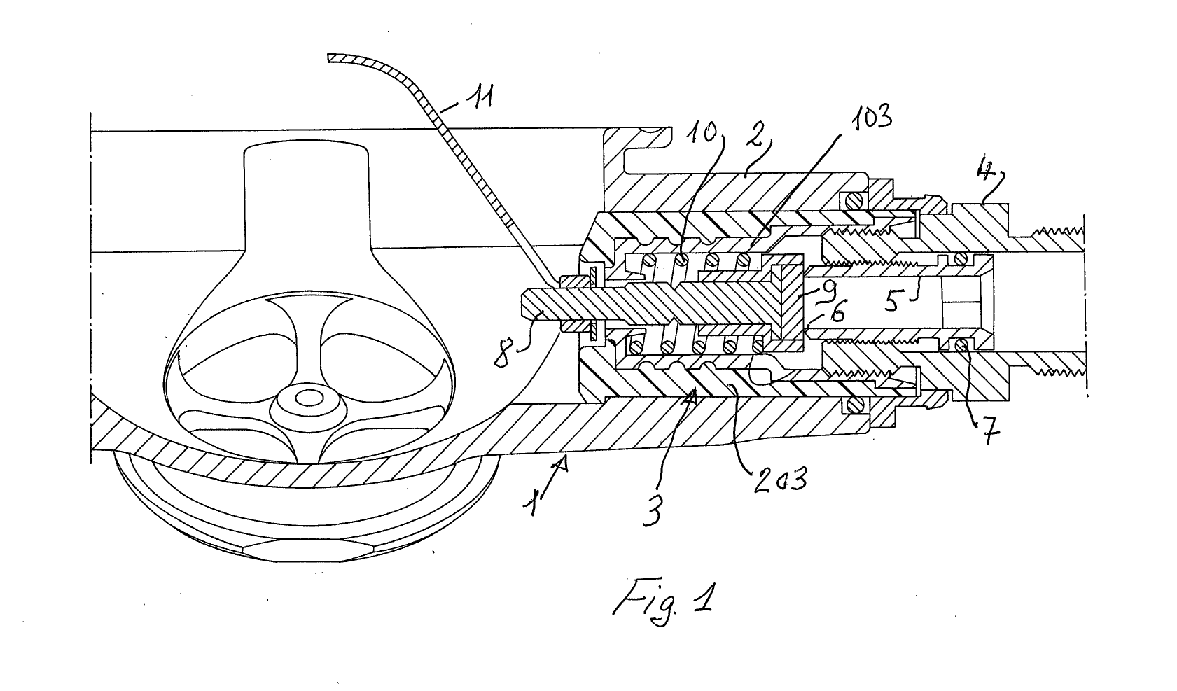

### BACKGROUND OF THE INVENTION

The present invention relates to second-stage valves for breathing-gas regulators for air aqualungs for underwater activity. More specifically, the present invention relates to the chamber controlling the air flow through these valves.

This chamber is normally made of metal. This is undoubtedly the best choice from the point of view of the strength of the threads and good thermal conductivity. However, it has the disadvantage of being expensive and, more particularly, heavy.

As is known, it is advantageous if the weight of the second stage is kept as low as possible to reduce jaw fatigue, because the diver holds the second stage in his or her mouth by means of the mouthpiece.

In the past some manufacturers, including MARES, made this component in one piece with the regulator casing, which is thermoplastic. This reduced costs and weight but the component did not perform as well as desired in cold waters due to the poor thermal conductivity of the thermoplastic. Also, significantly, the threaded parts of the chamber could be damaged by the metal connector of the compressed-air hose, or could suffer slight deformations which could result in variations in the relative positions of the valve and its seat, with the consequent possibility of slight leakages through the valve seat.

Using metal for the chamber solves these problems, but increases its weight and cost.

### SUMMARY OF THE INVENTION

It is therefore an object of the present invention to provide a second-stage valve for a breathing-gas regulator for an air aqualung for underwater activity, capable of overcoming the problems of known valves.

According to the invention, this object is achieved by making said valve in two parts, namely a metal inner liner, which is threaded, and overmoulding onto this metal part the body of the valve in a thermoplastic. If greater thermal conductivity is desired, for regulators intended for use in cold waters, this body could be made of a conductive engineering polymer or a carbon-based composite.

### BRIEF DESCRIPTION OF THE DRAWING

Other objects and advantages of the present invention will become clearer in the course of the following description, which refers to the appended drawing showing part of a regulator with a valve according to the invention in axial section.

### DESCRIPTION OF THE PREFERRED EMBODIMENT OF THE INVENTION

Referring to the drawing, reference 1 denotes part of the casing of the regulator. The casing 1 has on one side a cylindrical tubular extension 2 housing the chamber 3 of the second-stage valve. This chamber 3 is connected at one end, in a manner known per se, to an element 4 screwed to the chamber 3 itself and provided with a threaded tubular passage into which is screwed a tube 5 on the end of which is the valve seat 6. A seal 7 is inserted between the tube 5 and the element 4. The element 4 is in turn connected to the first stage of a compressed-air bottle (not shown).

The chamber 3 houses the stem 8 of the open/close element 9 which acts on the seat 6. This open/close element is permanently pushed in a direction of closure against the seat 6 by a spring 10. The free end of the stem 8 projects out of the chamber 3 and is connected to a lever 11 that works in conjunction with a constant-pressure diaphragm (not shown) which is sensitive to the external pressure, in such a way as to move the open/close element 9 away from the seat 6 every time the diver breathes in, so that the diver is supplied with however much air is required each time. This much is known, and is part of the prior art.

As mentioned earlier, in the introduction to the description, the chamber 3 is normally made of metal. This is undoubtedly the best choice as regards the strength of the thread between the element 4 and the chamber itself and also as regards good thermal conductivity of this chamber. However, it has the disadvantage of being expensive and, more particularly, heavy.

On the other hand, although costs and weight could be reduced by making this component in one piece with the thermoplastic casing, as proposed, it would have the disadvantage that it would not perform as well as desired in cold waters owing to the poor thermal conductivity of the thermoplastic. In addition, the threaded plastic parts can easily be damaged by the metal connector 4 of the compressed-air hose, or can suffer slight deformations which can vary the relative positions of the valve 9 and its seat 6, with the consequent possibility of slight leakages through the valve seat.

According to the present invention, it has been found that it is possible to overcome all the disadvantages of the prior art by making the chamber 3 of the valve with a thin metal inner liner 103, and overmoulding a coating 203 of thermoplastic onto this metal liner 103.

If it is wished to improve the thermal conductivity in this part of the regulator, so that the regulator can be used in very cold waters, the metal liner 103 can be overmoulded with a coating 203 of a heat-conducting engineering polymer or a carbon-based composite.

The present invention is not of course limited to the embodiment illustrated and described, but rather encompasses all such practical variants as may be applied to a second-stage valve for a breathing-gas regulator for underwater activity, for the objects described above.

I claim:

1. Second-stage valve for breathing-gas regulator for air aqualung for underwater activity, of the type comprising a chamber which houses the stem of an open/close element that is pushed permanently in a direction of closure against the seat of the breathing-air release valve by a spring, the free end of this stem being connected to a lever that works in conjunction with a constant-pressure diaphragm and that opens said valve in opposition to the action of said spring, said valve being characterized in that said chamber comprises a thin metal inner liner coated with a coating of plastic or composite material.

2. Valve according to claim 1, characterized in that said coating of material is applied to the metal liner by overmoulding.

3. Valve according to claim 1, characterized in that said plastic of the coating is a carbon-based composite.

4. Valve according to claim 1, characterized in that said plastic of the coating is a thermoplastic.

5. Valve according to claim 1, characterized in that said plastic of the coating is a heat-conducting engineering polymer.
